(19) United States
(12) Patent Application Publication
(10) Pub. No.: US 2015/0128042 A1
(43) Pub. Date: May 7, 2015

(54) MULTITASKING EXPERIENCES WITH INTERACTIVE PICTURE-IN-PICTURE

(71) Applicant: Microsoft Corporation, Redmond, WA (US)

(72) Inventors: John E. Churchill, Monroe, WA (US); Joseph Wheeler, Sammamish, WA (US); Jérôme Vasseur, Bothell, WA (US); Thomas Fuller, Seattle, WA (US)

(73) Assignee: Microsoft Corporation, Redmond, WA (US)

(21) Appl. No.: 14/071,535

(22) Filed: Nov. 4, 2013

(51) Int. Cl. G06F 3/0484; G06F 3/0488; G06F 3/0482

(52) U.S. Cl. CPC G06F 3/04842; G06F 3/0482; G06F 3/0488
USPC 715/718

(57) ABSTRACT

A user interface (“UI”) includes a personalized home screen that can be brought up at any time from any experience provided by applications, games, movies, television, and other content that is available on a computing platform such as a multimedia console using a single button press on a controller, using a “home” gesture, or using a “home” voice command. The home screen features a number of dynamically maintained visual objects called tiles that represent the experiences available on the console. An application can be “snapped” to the application that fills the PIP so that the snapped application renders into a separate window that is placed next to the UI for the filled application. The user interface is further adapted so that the user can quickly and easily switch focus between the tiles in the home screen and resume an experience in full screen.

### BACKGROUND

Computing platforms typically support a user interface (“UI) that enables users to interact with a platform. Computing platforms such as multimedia consoles have evolved to include more features and capabilities and provide access to an ever increasing array of entertainment, information, and communication options. As a result, there exists a need for UIs that provide a full set of features and capabilities while still being easy to use that enable users to get the most out of their computing platforms while maintaining a satisfying and rich user experience.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A user interface (“UI”) includes a personalized home screen that can be brought up at any time from any experience provided by applications, games, movies, television, and other content that is available on a computing platform such as a multimedia console using a single button press on a controller, using a “home” gesture, or using a “home” voice command. The personalized home screen features a number of visual objects called tiles that represent the experiences available on the console. The tiles are dynamically maintained on the personalized home screen as their underlying applications run. Within the larger UI, one of the tiles on the personalized home screen is configured as a picture-in-picture (“PIP”) display that can be filled by the graphical output of an application that is currently running. Other tiles show shortcuts to the most recently used and favorite applications. An application can be “snapped” to the application that fills the PIP so that the snapped application renders into a separate window that is placed next to the UI for the filled application. That way, the user can readily engage in multitasking experiences with the snapped and filled applications both in the personalized home screen and in full screen. The user interface is further adapted so that the user can quickly and easily switch focus between the tiles in the personalized home screen and resume an experience in full screen.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### DESCRIPTION OF THE DRAWINGS

FIG. 1 shows an illustrative computing environment in which the present multitasking experiences with interactive picture-in-picture (“PIP”) may be implemented;

FIG. 2 shows illustrative features that are supported by a home application that executes on a multimedia console;

FIGS. 3-21 show various illustrative screenshots of an interactive user interface that supports the present multitasking experiences with interactive PIP;

FIG. 22 shows an illustrative layered software architecture that may be used to implement various aspects of the present multitasking experiences with interactive PIP;

FIG. 23 is a flowchart of an illustrative method by which aspects of the present multitasking experience with interactive PIP may be implemented;

FIG. 24 shows a block diagram of an illustrative computing platform that may be used in part to implement the present multitasking experiences with interactive PIP;

FIG. 25 is a simplified block diagram of an illustrative computer system such as a personal computer (“PC”) that may be used in part to implement the present multitasking experiences with interactive PIP;

FIG. 26 shows a block diagram of an illustrative computing platform that may be used in part to implement the present multitasking experiences with interactive PIP; and

FIG. 27 shows a functional block diagram of a camera system that may be used in part to implement the present multitasking experiences with interactive PIP.

Like reference numerals indicate like elements in the drawings. Elements are not drawn to scale unless otherwise indicated.

### DETAILED DESCRIPTION

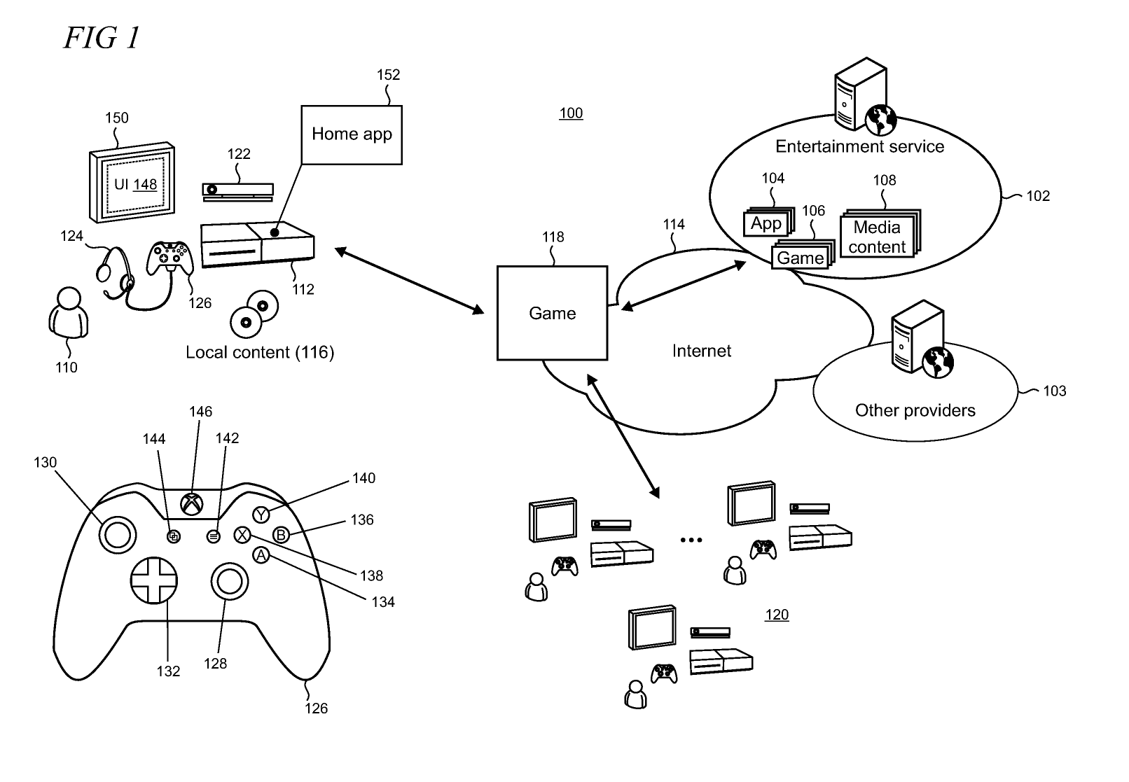

FIG. 1 shows an illustrative computing environment 100 in which the present multitasking experiences with interactive picture-in-picture (“PIP”) may be implemented. An entertainment service 102 can typically expose applications (“apps”) 104, games 106, and media content 108 such as television shows and movies to a user 110 of a multimedia console 112 over a network such as the Internet 114. Other providers 103 may also be in the environment 100 that can provide various other services such as communication services, financial services, travel services, news and information services, etc.

Local content 116, including apps, games, and/or media content may also be utilized and/or consumed in order to provide a particular user experience in the environment 100. As shown in FIG. 1, the user is playing a particular game title 118. The game 118 may execute locally on the multimedia console 112, be hosted remotely by the entertainment service 102, or use a combination of local and remote execution in some cases using local or networked content/apps/games as needed. The game 118 may also be one in which multiple other players 120 with other computing devices can participate.

The user 110 can typically interact with the multimedia console 112 using a variety of different interface devices including a camera system 122 that can be used to sense visual commands, motions, and gestures, and a headset 124 or other type of microphone or audio capture device. In some cases a microphone and camera can be combined into a single device. The user may also utilize a controller 126 (shown in enlarged view in the lower left of FIG. 1) to interact with the multimedia console 112. The controller 126 may include a variety of physical controls including joysticks 128 and 130, a directional pad (“D-pad”) 132, “A,” “B,” “X,” and “Y” buttons 134, 136, 138, and 140 respectively, menu button 142 and view button 144. A centrally-located button, referred to in this application as the center button 146, is also provided. One or more triggers and/or bumpers (not shown) may also be incorporated into the controller 126. The user 110 can also typically interact with a user interface 148 that is shown on a display device 150 such as a television or monitor.

It is emphasized that the number of controls utilized and the features and functionalities supported by the controls in the controller 126 can vary from what is shown in FIG. 1 according to the needs of a particular implementation. In addition in the description that follows various button presses and control manipulations are described. It is noted that those actions are intended to be illustrative. For example, the user may actuate a particular button or control in order to prompt a system operating on the multimedia console 112 to perform a particular function or task. It will be appreciated that the particular mapping of controls to functions can vary from that described below according the needs of a particular implementation. As used here, the term “system” encompasses the various software (including the software operating system (“OS”)), hardware, and firmware components that are instantiated on the multimedia console and its peripheral devices in support of various user experiences that are provided by the console.

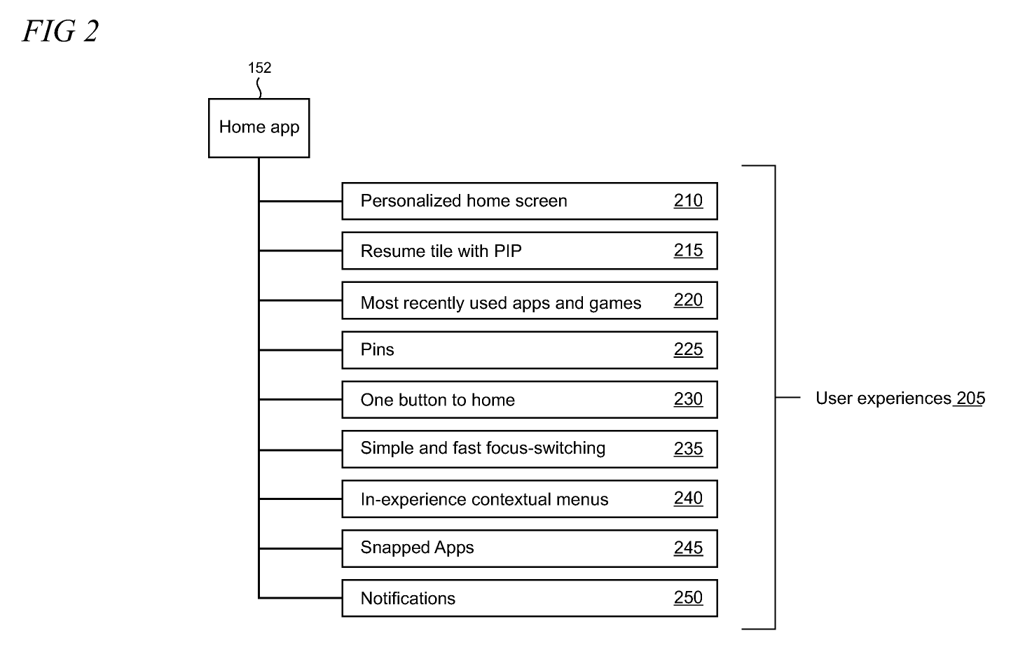

A home app 152 executes on the multimedia console 112 in this illustrative example. As shown in FIG. 2, the home app 152 is configured to provide a variety of user experiences 205 when operating as a part of the system running on the multimedia console 112. Some of the experiences may execute simultaneously to implement multitasking in some cases. The user experiences 205 include a personalized home screen 210 that is shown on the UI 148 (FIG. 1). The personalized home screen 210 can be arranged to support a number of graphic tiles including a resume tile 215 that employs one or more interactive PIPs. Shortcuts to most recently used apps/games 220 can also be included in the personalized home screen 210 as tiles. Pins 225 are tiles that are user-selectable for inclusion in the personalized home screen and can generally represent, for example, shortcuts to apps/games that the user particularly likes and/or uses the most often.

The tiles in the personalized home screen can be configured as “live” tiles in some implementations so that they show or represent activity of any underlying running app/game right on the personalized home screen. For example, a news app could display news headlines, sports scores, and the like from the personalized home screen. In some cases, the tiles can be configured to enable some interactivity with the underlying application through user interaction with the tile itself. For example, a tile could be configured to expose user-accessible controls to change tracks or playlists in an underlying music app that is running on the multimedia console.

The user experiences 205 further include a one button to home experience 230 in which the user 110 can push the center button 146 (FIG. 1) on the controller to launch or return to the personalized home screen at anytime during a session on the multimedia console 112. The user can also make a particular “home” gesture that is captured by the camera system 122 and associated gesture recognition system that is implemented on the multimedia console 112, or speak a voice command such as “home” or its non-English language equivalents, or other words or word combinations to launch or return to the personalized home screen. Simple and fast switching of focus 235 from one app/game to another is also supported. In-experience contextual menus 240 may be invoked by the user 110 in order to launch menus that are specifically configured for a user experience provided by the context of a given app or game. Some apps/games may be snapped to the PIP (indicated by reference numeral 245) in the personalized home screen. Various notifications 250 may also be supported in the personalized home screen.

Each of the user experiences 205 are described in more detail below.

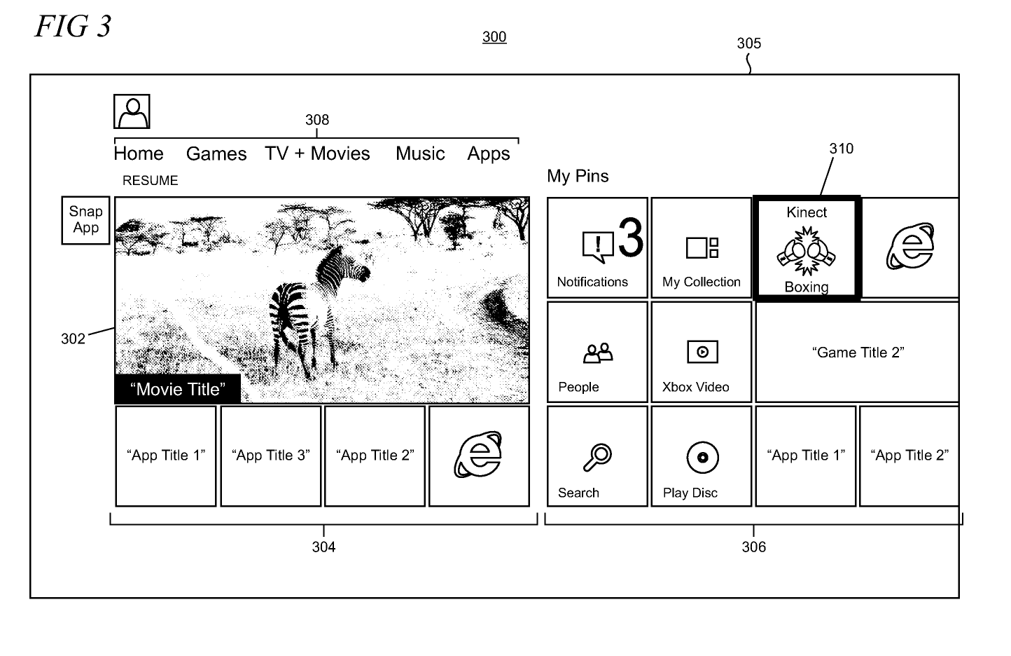

FIG. 3 shows a screenshot 300 of a UI that includes an illustrative personalized home screen 305. It is emphasized that the particular personalized home screen shown in this example is intended to be illustrative and the home screens utilized in various implementations of the present multitasking experiences with interactive PIP can vary from what is shown by content, format, and layout according to particular needs. In addition, in the screenshot 300 and those that follow, the UIs shown have been simplified for clarity of exposition as black and white line drawings.

The personalized home screen 305 in FIG. 3 shows that the user 110 is currently consuming a movie that is displayed in the large resume tile 302 that is implemented as an interactive PIP within the larger UI. As the movie continues, the resume tile 302 is continuously refreshed so that the user 110 can watch the movie, use transport controls such as fast ahead, pause, audio mute, bring up menus and go to full screen, etc., all while interacting with the rest of the objects that are provided on the personalized home screen 305. In some implementations, more than one PIP can be utilized and a given PIP can be implemented to be within another PIP (i.e., a PIP within a PIP) and the user 110 can interact with and/or control each of the various PIPs and their experiences from the personalized home screen. In addition, a given PIP does not have to be mapped on a one-to-one basis to an app/game so that it can be used to support multiple running applications. In some implementations, instead of representing an experience from a running app/game a PIP can be configured to represent a link for a launching an app/game. For example, upon start up of the multimedia console 112, a PIP could be used to display a launch tile for the last app/game that was running in the resume tile 302 before the console was powered down.

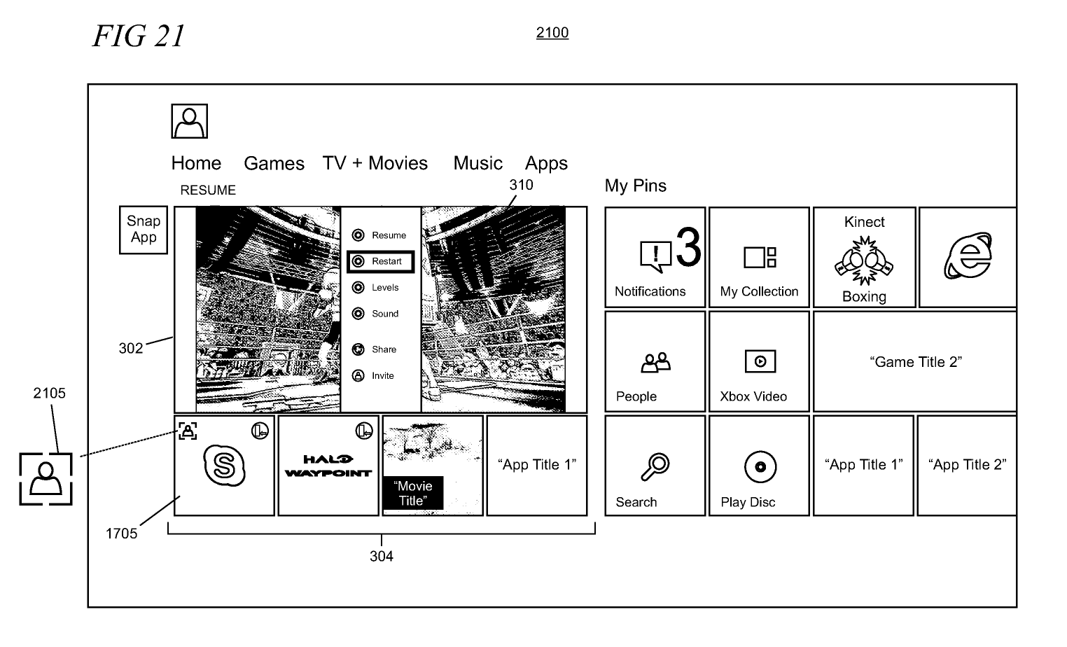

Below the resume tile 302 is a row of four tiles, in this illustrative example, that represent the most recently used apps/games, referred to here as the MRU tiles 304. The particular apps/games that are included in MRU tiles 304 can be expected to change over time as the user 110 launches and closes apps/games during the course of a session. The MRU tiles 304 can also be used in some implementations to represent either or both links for launching their respective underlying apps/games and live, currently executing applications that are running in the background (an example of an application that is running in the background while shown in the MRU tiles 304 is provided below in the text accompanying FIG. 21). When an MRU tile is representing a currently executing app/game in some cases, the user can interact with the tile to control the experience such a bringing up an in-experience menu, pause/resume a game or movie, or invoke some other feature. In addition, the MRU tiles themselves can be configured to support one or more PIPs into which running apps/games may render experiences.

Next to the MRU tiles 304, in this illustrative example, are several rows of tiles which comprise pins 306. The pins 306 can represent the apps/games that the user 110 likes the most and/or uses the most frequently and be used as launch tiles. Typically, the system and/or home app is configured to enable the user 110 to pick which apps/games are included as pins on the personalized home screen 305. Alternatively, the system or home app may automatically populate some or all of the pins for the user 110. For example, the system/home app may apply various rules or heuristics to determine which apps/games are included as pins or analyze usage statistics, user-expressed preferences, user behaviors, or the like when populating tiles in the pins 306 on the personalized home page 305. When a pin is selected and activated by the user, its underlying app or game can be launched. In addition, in some implementations one or more of the pins can be configured to represent a currently executing app/game with user controllability (e.g., experience control, menus, etc.) and/or implement one or more PIPs, as with the MRU tiles described above. Other apps, games, and other content can typically be browsed, selected, and launched from the menu bar 308 that is located above the resume tile 302.

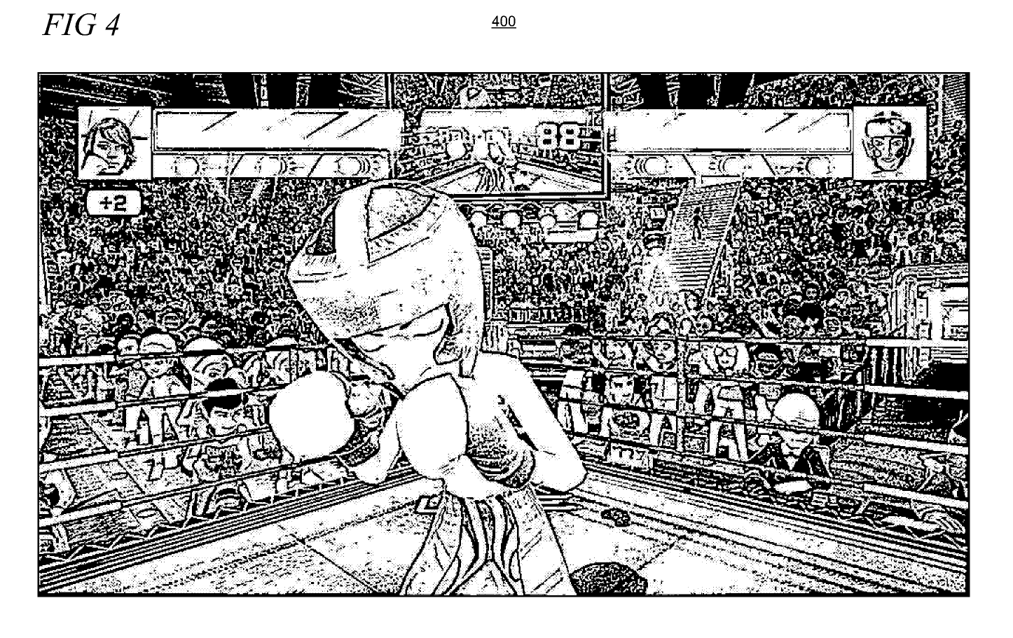

In this illustrative example, the user 110 has employed the controller 126 (FIG. 1), for example by manipulating the D-pad or joystick, to select a game tile 310 from among the pins 306 (the selection indicator is a rectangle with a thick border in this example). By activating a button on the controller (e.g., the “A” button 134), the game is launched (here, a boxing game) which then completely fills the UI supported by the multimedia console as shown in the screenshot 400 in FIG. 4. In some implementations, the game will restart from the point where the user was last playing. However, it is expected that the restart behavior can vary by application and it is typically up to the app/game developer to decide how a particular app/game will operate when launched as a pin. For example, some apps/games may restart from the user's last point of interaction, while others will start anew or at another point.

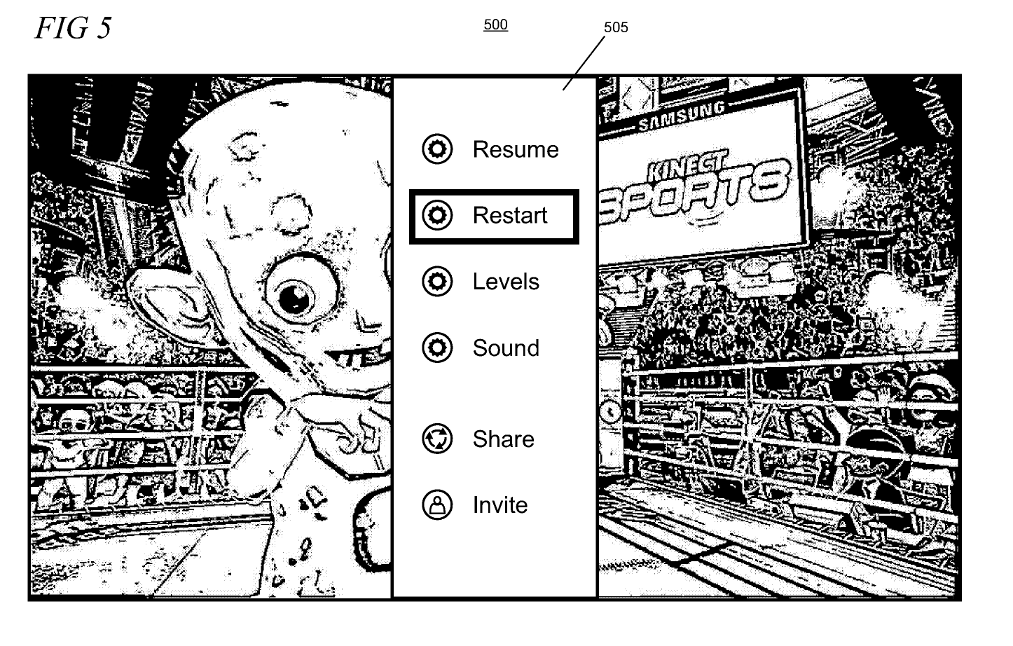

FIG. 5 is a screenshot 500 that shows an example of an in-experience contextual menu 505 that may be brought up by the user 110 during gameplay of the boxing game shown in screenshot 400 in FIG. 4. For example, the user 110 can press the menu button 142 on the controller 126 in order to invoke the menu 505. Calling up an in-experience menu in this particular example will pause the gameplay and give the user 110 several menu choices, as shown. Here, the user 110 has selected the “restart” option with the controller and could restart the boxing game by pressing the “A” button 134, for example. As with the pin described above, the choices, content, and behaviors provided by a particular in-experience menu are typically matters of design choice for the app/game developer. Thus, for example, some multiplayer games might not support a pause feature through the in-experience menu.

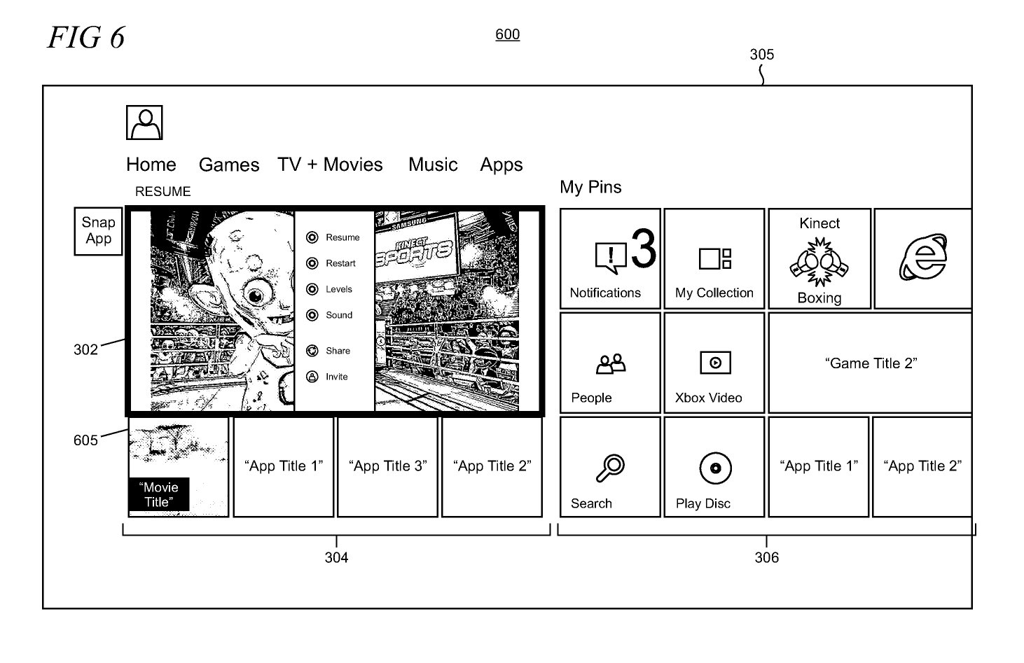

If the user 110 wishes to go back to the personalized home screen from the filled game screen shown in FIG. 5, then the user can press the center button 146, for example, on the controller 126. As noted above, the center button 146 can be configured to bring the user back to the personalized home screen from any experience on the multimedia console's UI at anytime. FIG. 6 is a screenshot 600 that shows the UI after returning to the personalized home screen 305 from the filled game screen in FIG. 5. Now the large resume tile 302 shows the game experience (with the displayed in-experience menu) that the user 110 just left. The previous occupant of the resume tile, the movie, moves down to the first position (i.e., the leftmost position as indicated by reference numeral 605) in the MRU tiles 304. In this particular example, the in-experience menu is up and the gameplay is paused. Typically, if the user had not paused the gameplay by calling up the in-experience menu before going back to the personalized home screen 305, the game would continue to run as it would in full screen, and the resume tile would display the ongoing gameplay. However, the particular behavior exhibited when running in the resume tile 302 can vary by application in accordance with the developer's design choices.

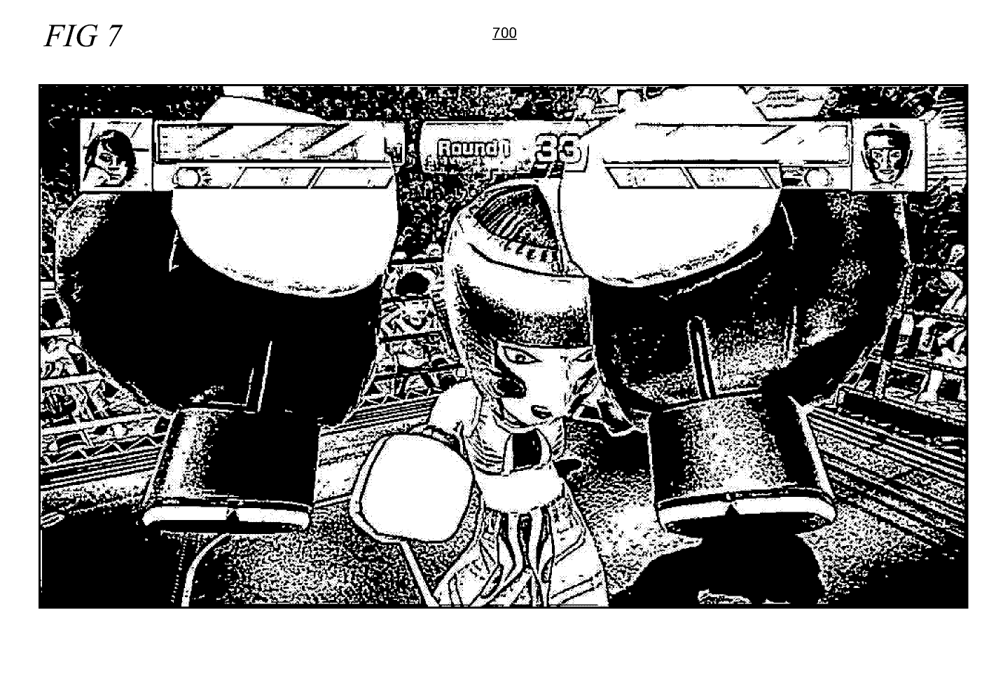

As shown in FIG. 6, the user 110 has employed the controller 126 to move the selection indicator to the resume tile 302. When the user presses the “A” button 134, for example on the controller 126, the boxing game will then resume and fill the UI completely as shown in the screenshot 700 in FIG. 7. The particular behavior of an app/game when resuming is again a matter of design choice for the developer and can vary. In this example, the boxing game has closed its in-experience menu and resumes gameplay.

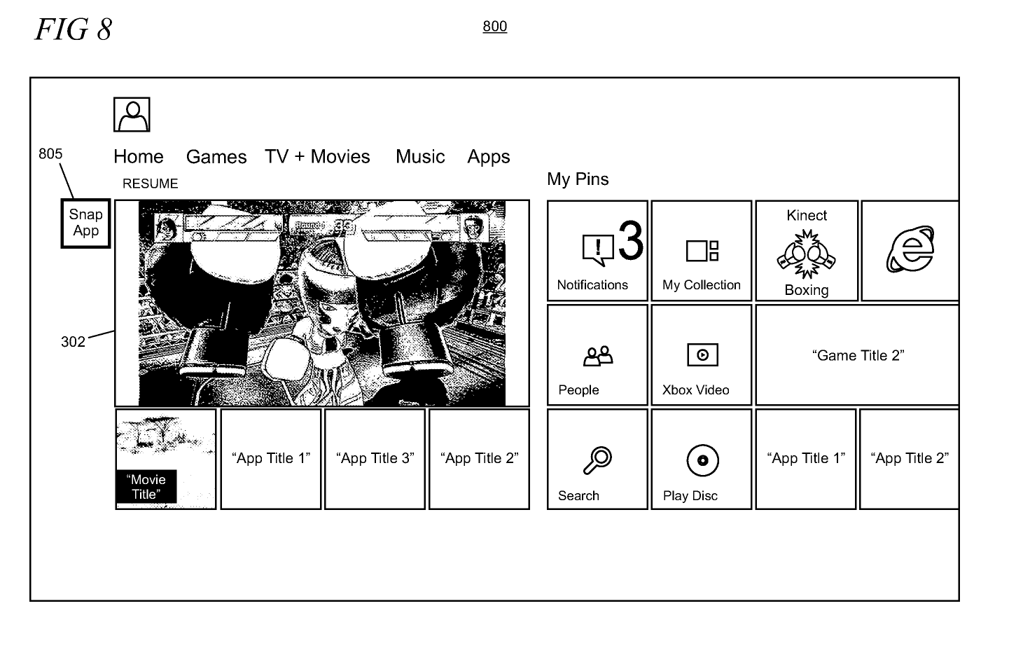

FIG. 8 is a screenshot 800 that shows a “snap app” button 805 being selected by the user 110 (FIG. 1) using the controller 126. The snap app button 805 enables the user to launch an app/game that provides an experience that executes simultaneously with whatever is running in the resume tile 302. That experience renders into a window that is located, i.e., “snapped” to the side of the filled app's UI so that the user can multitask by interacting with both the filled app and the snapped app. The term “filled app” refers to an app/game that is configured to be capable of rendering into substantially the full extent of the UI. It is anticipated that some apps/games will only be configured to run as filled apps, others will only be configured to run as snapped apps, while yet other apps/games will be configured to run as either snapped or filled apps.

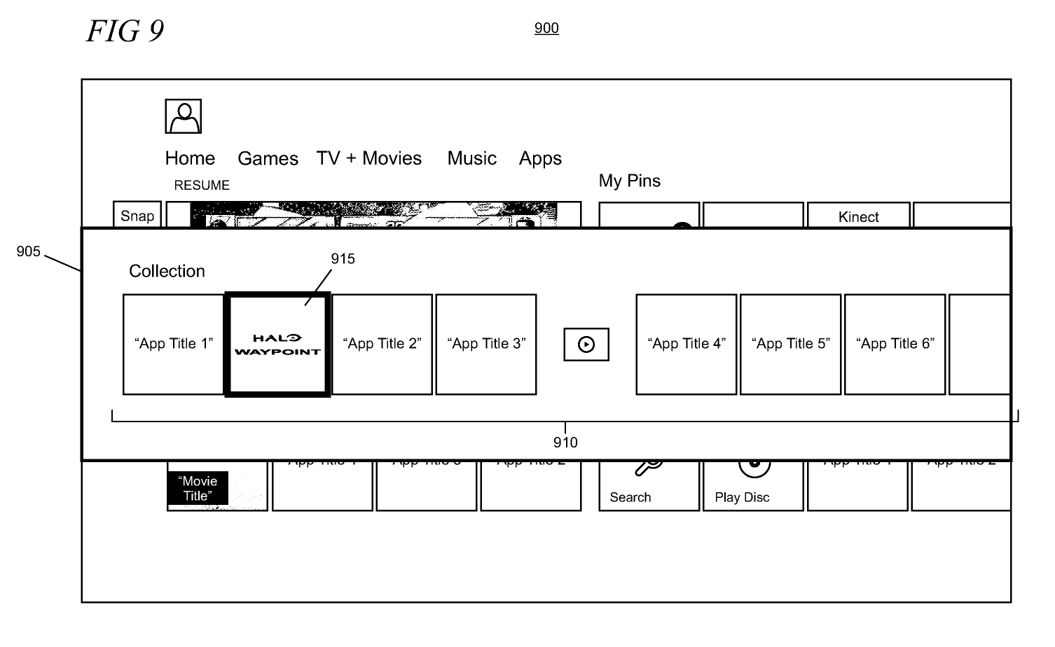

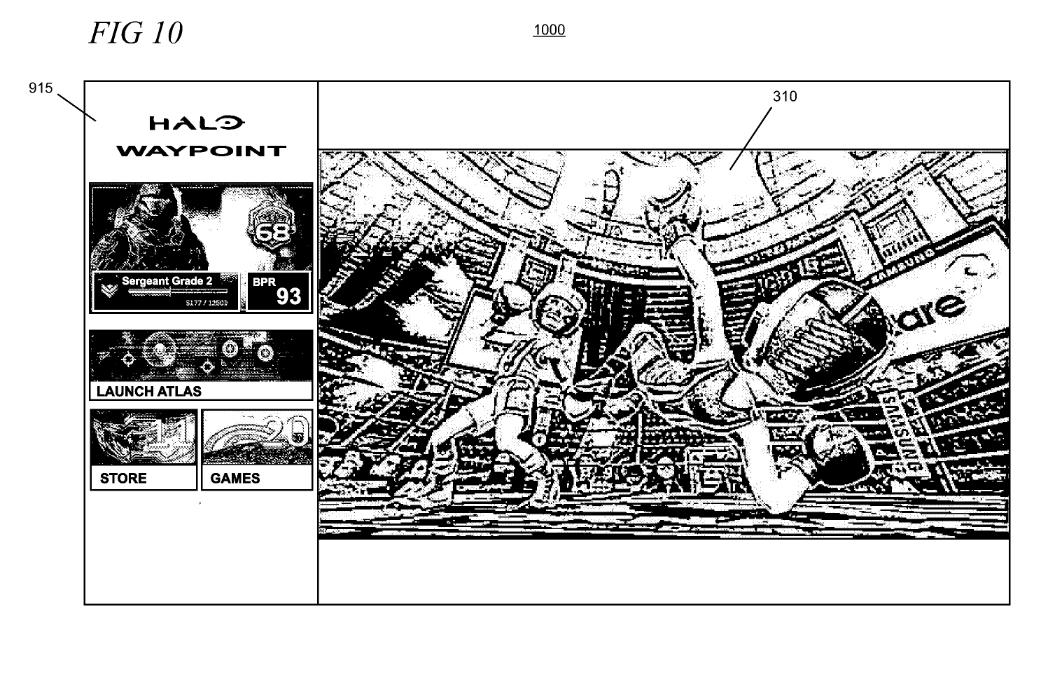

When the user 110 selects the snap app button 805 and presses the “A” button 134, for example, on the controller 126, a snap app menu 905 opens on the UI as shown in the screenshot 900 in FIG. 9. The snap app menu 905 lists various snappable experiences provided by apps and games in a scrollable filmstrip 910, as shown. In this illustrative example, the user has selected an icon for an app 915 titled “Halo Waypoint.” App 915 is an example of a “hub app” that functions as a central location for content and information related to a particular gaming experience. When the user presses the “A” button 134, for example, on the controller 126 the app 915 launches on the UI as a snapped experience, as shown in the screenshot 1000 in FIG. 10. Here, the snapped app 915 provides various player statistics/information as well as several selectable buttons (e.g., “launch atlas,” “store,” and “games”) that enable the user 110 to navigate to various experiences that will render into the snapped app UI window.

FIG. 10 shows the experience from the snapped app 915 being rendered into a window that is snapped to left side of the filled app which, in the example, is the boxing game 310. In alternative implementations, the snapped app can be located elsewhere in the UI. Both the snapped app 915 and the filled app run at the same time so that the gameplay in the boxing game continues while the hub app provides its own interactive experiences for the user. As with the in-experience menus for filled apps, if the user presses the menu button 142 on the controller 126, an in-experience menu (not shown in FIG. 10) having particular context for the snapped app 915 is brought up.

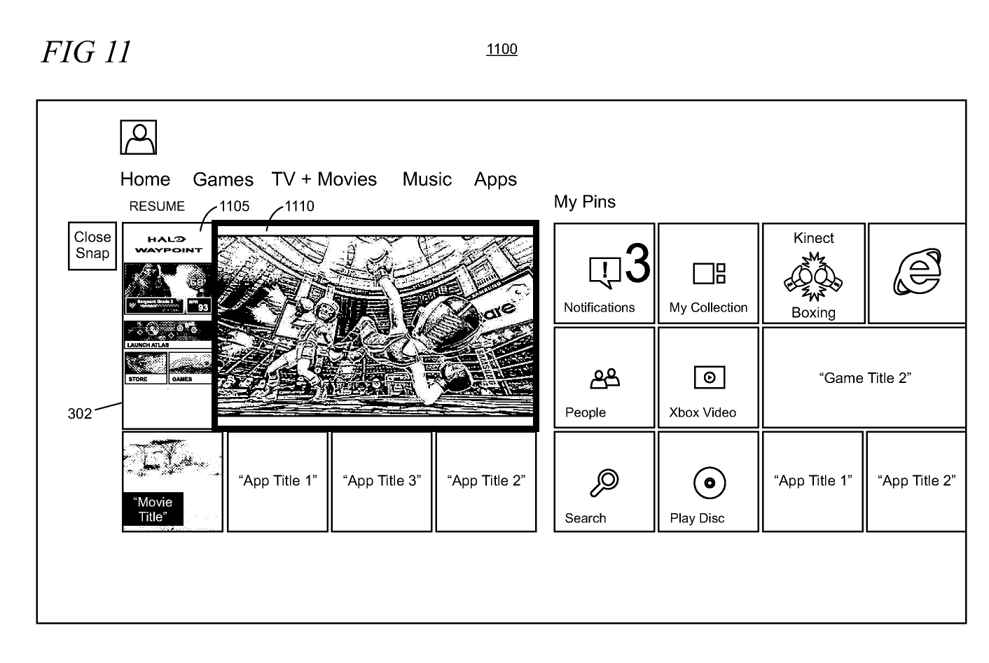

If the user 110 uses the center button 146 to go back to the personalized home screen at this point, then the resume tile 302 is broken down into two smaller sub-tiles 1105 and 1110 as shown in the screenshot 1100 in FIG. 11. By providing the two sub-tiles in the resume tile, the user 110 can simply and quickly switch focus between the experiences provided by the snapped hub app and the boxing game. An app/game that has focus is typically the target of user inputs from the system such as controller events and events associated with motion-capture/gesture-recognition and voice commands.

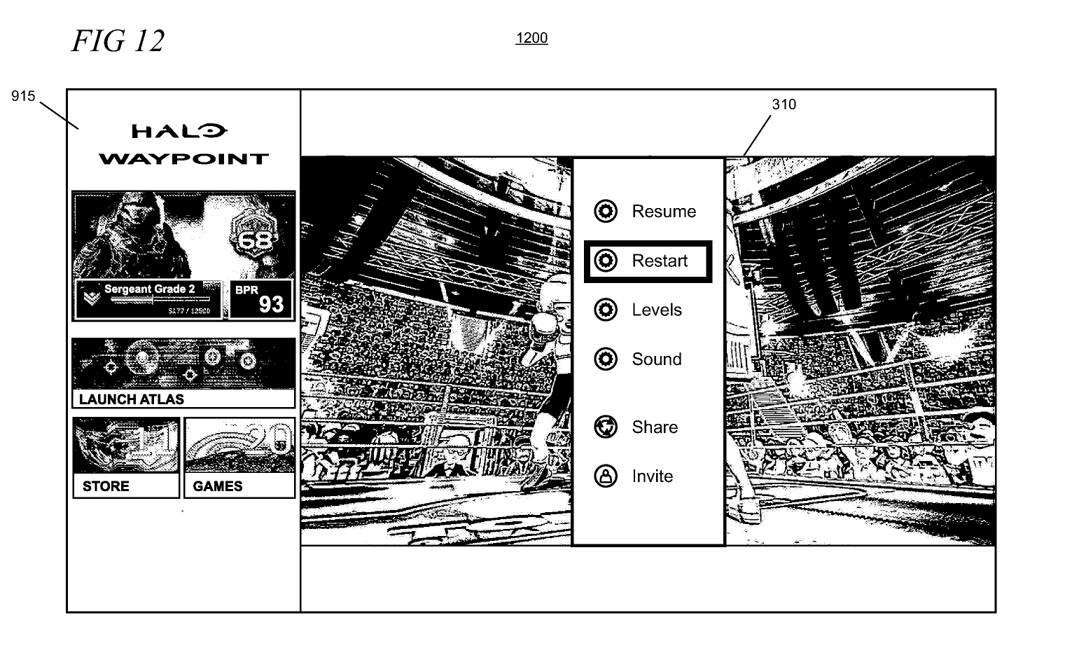

As shown in FIG. 11, the user 110 has employed the controller 126 to move the selection indicator to the larger sub-tile 1110 in the resume tile 302. When the user presses the “A” button 134, for example, on the controller 126 the boxing game 310 will then resume as shown in the screenshot 1200 in FIG. 12 and receive focus. In addition to focus switching from the personalized home screen, the system and/or home app 152 may be configured so that center button 146 may be double tapped to switch focus between a filled and snapped app without first going to the personalized home screen.

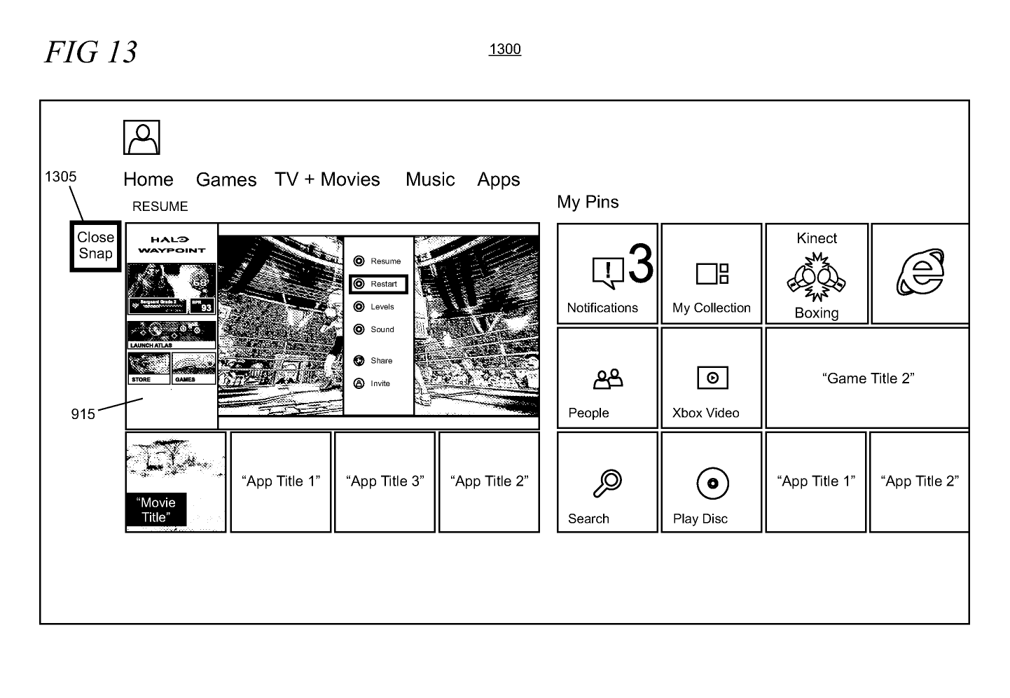

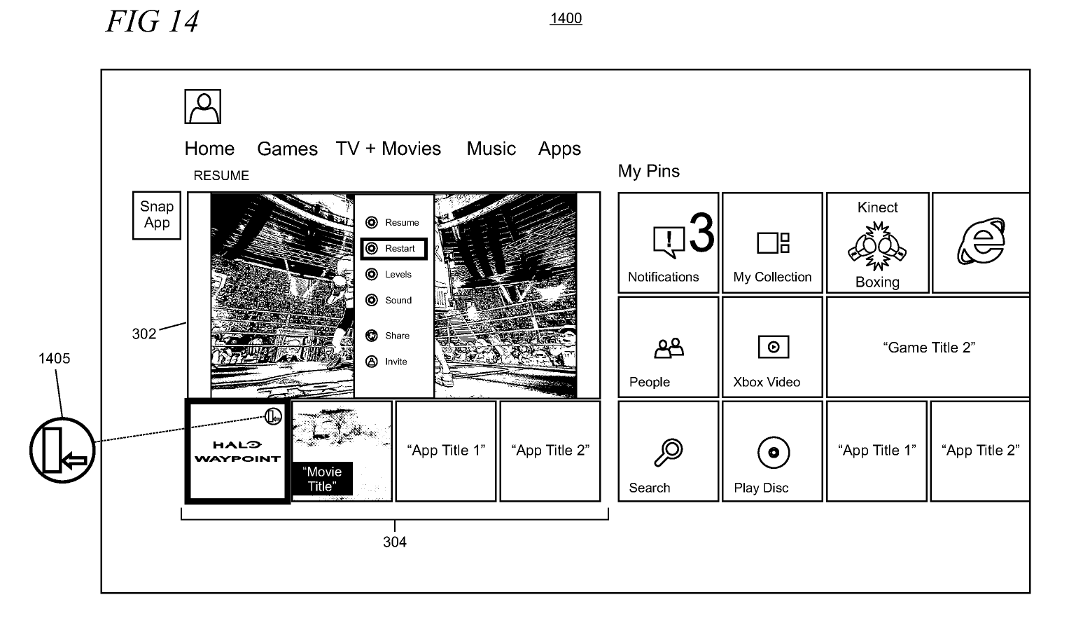

As shown in the screenshot 1300 in FIG. 13 when the waypoint app 915 is snapped in the personalized home screen, the snap app button 805 (FIG. 8) is replaced with a “close snap” button 1305. Here, the user 110 has employed the controller 126 to move the selection indicator to the close snap button 1305. When the user presses the “A” button 134, for example, on the controller 126 the snapped app 915 closes and the experience is removed from the resume tile as shown in the screenshot 1400 in FIG. 14. It is noted that the term “closes” can mean different things for different apps/games depending on developer design choices. In some cases, an app/game may still run in the background even though it is not actively rendering into the UI as a snapped or filled app in the personalized home screen. An example of this background behavior is presented below in the text accompanying FIG. 21 below.

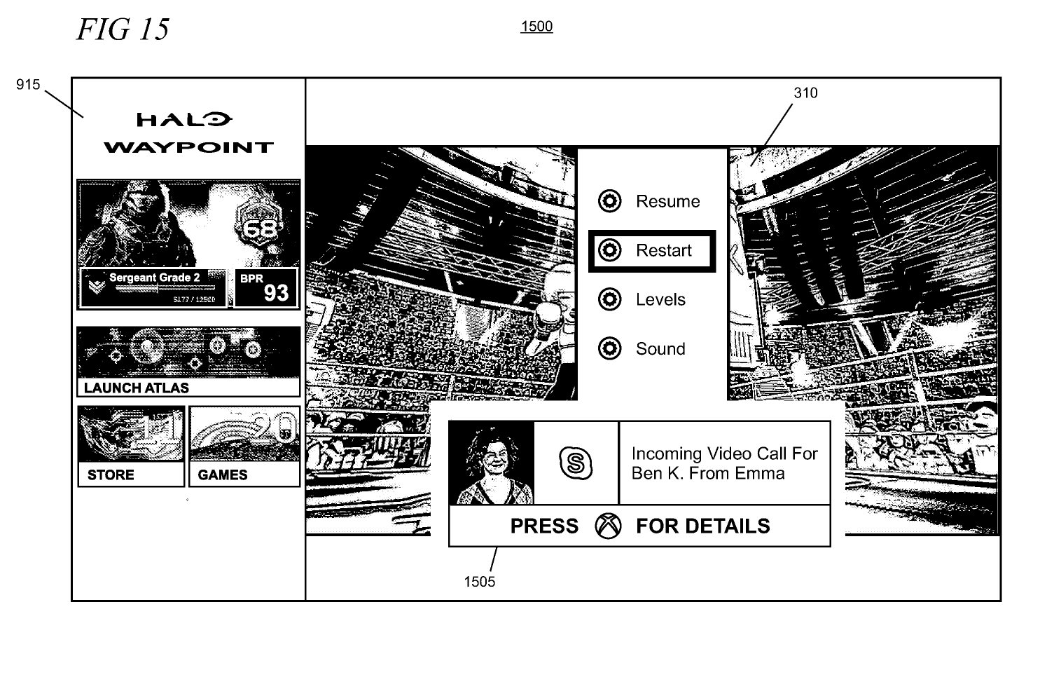

As shown in FIG. 14, the previously snapped app 915 moves to the first position in the row of MRU tiles 304 below the resume tile 302. A decoration 1405 (shown in an enlarged view) is provided in the first MRU tile to indicate the visual state that the app will take when resumed. In this case, the app 915 will resume as a snapped app when re-launched (e.g., when the user 110 selects the MRU tile and presses the “A” button 134, for example, on the controller 126) as shown in the screenshot 1500 in FIG. 15.

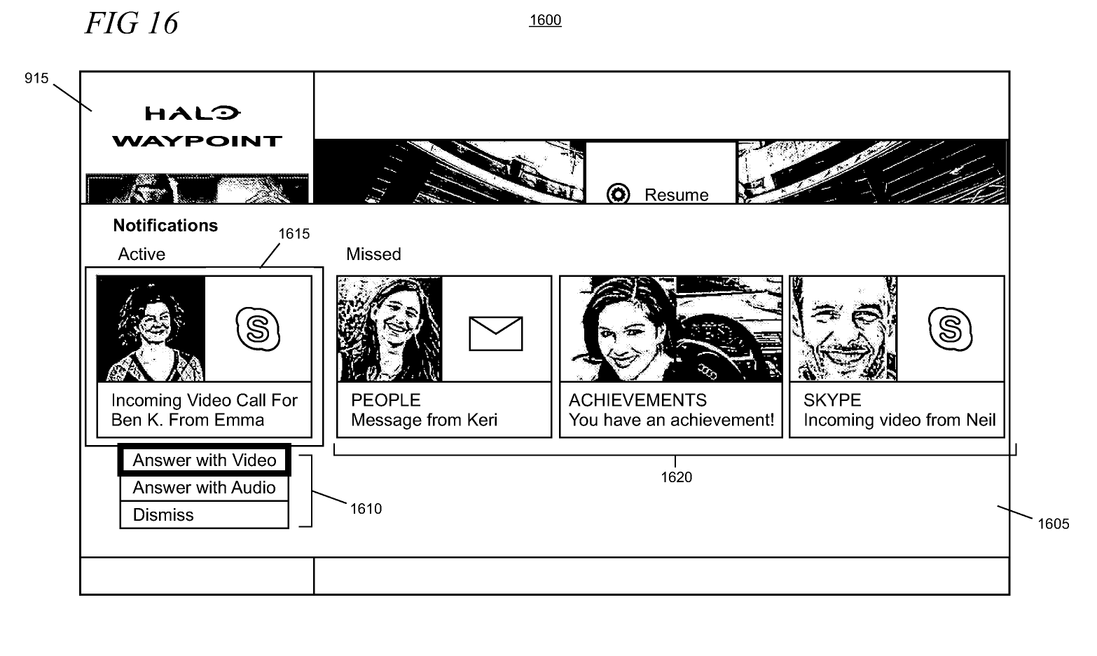

FIG. 15 also shows an illustrative example of a notification 1505 being displayed on the UI for the boxing game 310. In some implementations, a notification can provide some initial information about it. In this example, the notification 1505 shows that it is an incoming call from a caller on a VoIP (Voice over Internet Protocol) service for example supplied by a provider 103 (FIG. 1). The user 110 can interact with the notification 1505 by pressing the center button 146, for example, on the controller 126. Instead of going to the personalized home page as usual, here the center button press will take the user 110 to a notification center 1605 as shown in the screenshot 1600 in FIG. 16. The notification center 1605 shows a number of options (indicated by reference numeral 1610) for the active notification 1615 as well as enables the user 110 to get information about notifications 1620 that may have been missed. Responding to a notification can take the user to either a filled or a snapped experience according to app/game design.

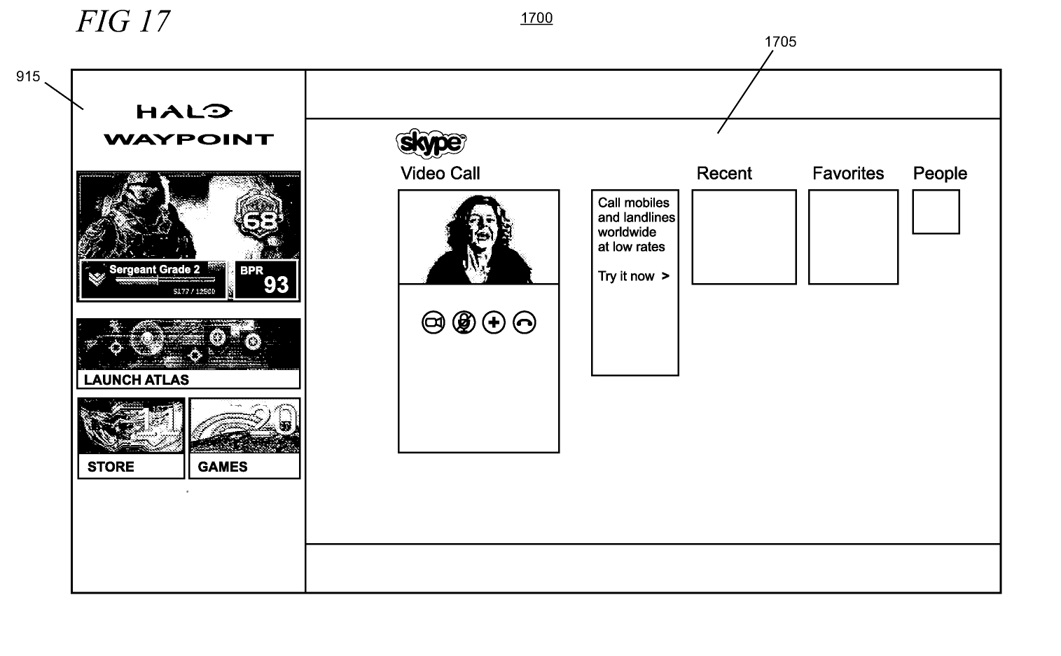

In this example, the user 110 has positioned the selection indicator and pressed the “A” button 134, for example, on the controller 126 in order to answer the call. This action invokes a link to start up a VoIP app 1705 which replaces the boxing game on the UI as shown in the screenshot 1700 in FIG. 17. The user 110 can then participate in the call through interaction with the VoIP app 1705.

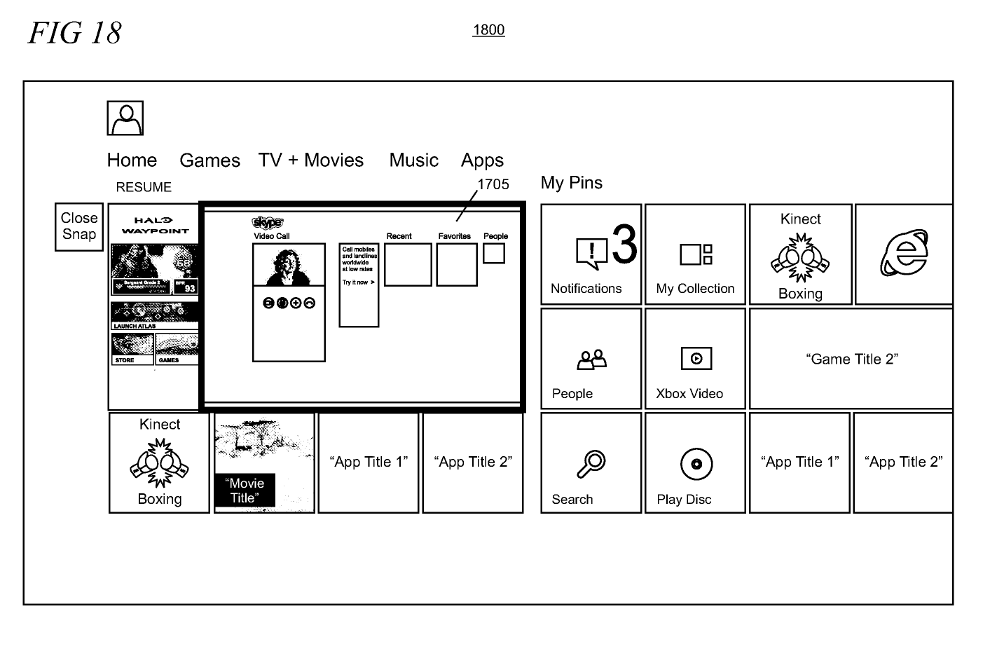

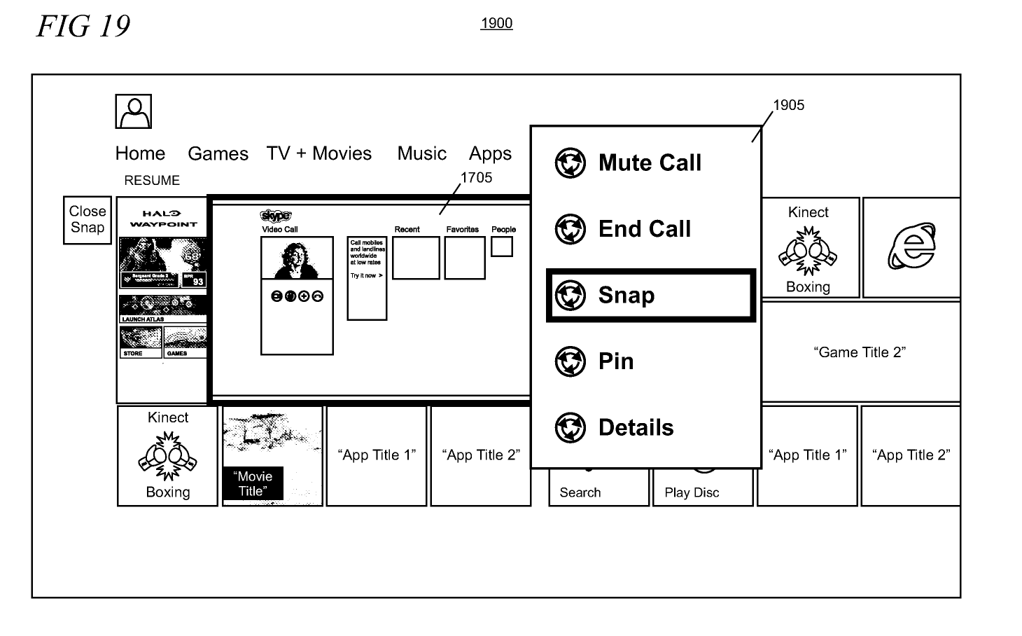

If the user presses the center button 146, for example, on the controller 126, the personalized home screen is again brought up on the UI as shown in screenshot 1800 in FIG. 18. As noted above, when the user presses the menu button 142, for example, on the controller 126 a menu will be displayed. The menu shown will depend on which tile the user happens to be on in the UI. In this example, the VoIP app 1705 is selected so an in-experience menu 1905 that has context for the VoIP app is displayed on the UI, as shown in the screenshot 1900 in FIG. 19.

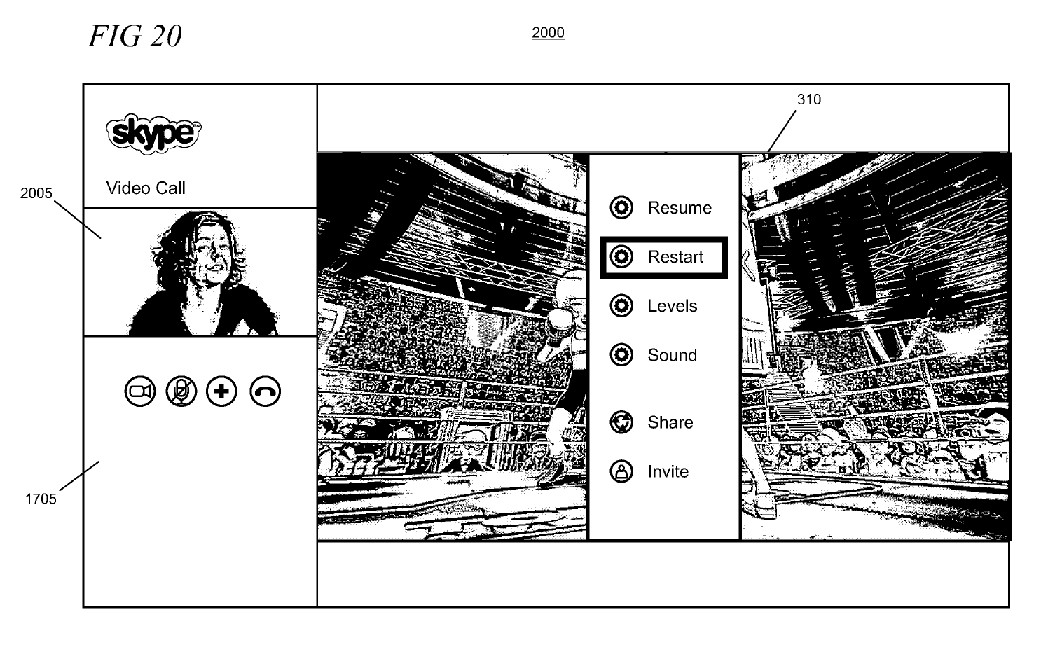

In this example, the in-experience menu 1905 provides several ways to interact with the call including muting, ending, snapping, pinning, and getting call details. As shown, the user 110 has selected “snap.” When the “A” button, for example, is pressed, the VoIP app 1705 is presented at the side of the UI (in this example, on the left side) as a snapped app that renders its experience into a smaller PIP 2005 and the previous application that was running, the boxing game 310 becomes the filled app as shown in the screenshot 2000 in FIG. 20. It is noted that the option to snap an app is typically only provided as a menu choice when an app is designed to support both snapped and filled configurations.

If the user 110 uses the center button 146 to go back to the personalized home screen at this point, and chooses to close the snapped app using the close snap button 1305 as described above, then the snapped VoIP app 1705 closes and moves to the first position in row of MRU tiles 304 below the resume tile 302. This behavior is shown in the screenshot 2100 in FIG. 21. As noted above, the term “closes” can mean different things for different apps/games. In this example, the VoIP app 1705 continues to run after being closed and will continue to transmit video and audio even though the VoIP app is no longer part of a visible experience on the UI. Other apps/games having communication features may be designed to exhibit similar background operation behaviors in some cases. A decoration 2105 (shown in an enlarged view) is provided in the first MRU the to indicate that the VoIP app 1705 is still active.

The system can be configured to inform currently running apps/games as to which of the various PIPs are being utilized to a support their experiences when the personalized home screen is being displayed. That way each running app/game has the option to adjust its experience depending on which PIP it is rendering into. For example as shown in FIG. 21, the VoIP app 1705 can be configured as a launch tile when placed in the row of MRU tiles 304. However, the VoIP app could also be configured to render into another PIP (not shown) that is supported on the MRU tile in some implementations. The VoIP app could, for example, show live video in the tile (that is scaled but otherwise the same as when rendered into the resume tile), a timer showing the elapsed time of the call, an invocable interactive menu, and the like.

While some apps and games may render their normal experience into all tiles the same way, other may change the way they render their experiences based on the size, location, number of PIPs currently being displayed, and/or other criteria being utilized on a given personalized home screen. For example, if rendering into a relatively small PIP on a live tile (e.g., on an MRU tile or a pin), an application may chose to simplify or modify what is rendered compared to what it may render when it has a larger PIP to work with such as with the resume tile 302 or with a PIP in a snapped experience. Alternatively, the application could choose to render something that is different from its normal output such as advertising, an attract screen that is designed to catch a user's attention, or other objects if, for example, a tile is not particularly appropriate or suited to normal output, or as a result of a developer's design choice.

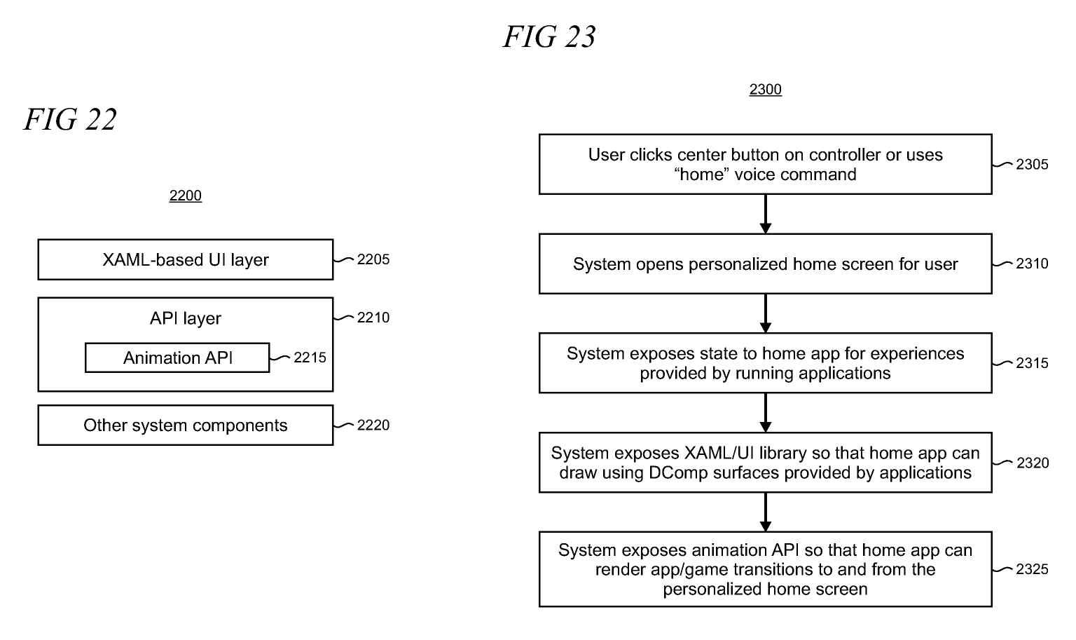

FIG. 22 shows an illustrative layered software architecture 2200 that may be used to implement various aspects of the present multitasking experiences with interactive PIP. The software architecture 2200 may be adapted for use by the system running on the multimedia console 112 (FIG. 1) and similar systems operating on other computing platforms and devices. A XAML-based UI layer 2205 provides a library of XAML (eXtensible Application Markup Language) methods and routines that can be accessed by the home app 152 when the personalized home screen is drawn into the UI. The system further exposes an API (application programming interface) layer 2210 that includes an animation API 2215 that enables apps/games to be rendered during the transitions to and from the personalized home screen. Other system components 2220 may also be utilized in some implementations to facilitate the various features and functionalities described here. For example, it will be appreciated that the XAML-based UI layer can be built on top of various sub-systems in the layer 2220 such as the DirectX render system.

FIG. 23 is a flowchart of an illustrative method 2300 by which various aspects of the present multitasking experiences with interactive PIP may be implemented. Unless specifically stated, the methods or steps shown in the flowchart and described below are not constrained to a particular order or sequence. In addition, some of the methods or steps thereof can occur or be performed concurrently and not all the methods or steps have to be performed in a given implementation depending on the requirements of such implementation. Some methods or steps may also be optionally utilized.

At step 2305, the user 110 (FIG. 1) clicks the center button 146 on the controller 126, or alternatively, makes a gesture that is recognized by a gesture recognition system on the multimedia console 102 as a “home” gesture, speaks a voice command such as “home” to create a user input event that instructs the system to open the user's personalized home screen. At step 2310, the system will open the personalized home page in response to the user input event. The system exposes the state of the system including all running apps/games to the home app 152 (FIG. 1) at step 2315. At step 2320, the XAML-based UI library is exposed so that the home app 152 can draw using Direct Composition (“DComp”) surfaces provided by the apps/games. The system further exposes the animation API 2215 (FIG. 22) to the home app so it may render app/game transitions to and from the personalized home screen at step 2325. Thus, the home app can redirect the video output from the running apps/games and manipulate it as needed to fit the spaces on the personalized home screen. For example, such manipulation can including scaling, sizing, repositioning, etc.

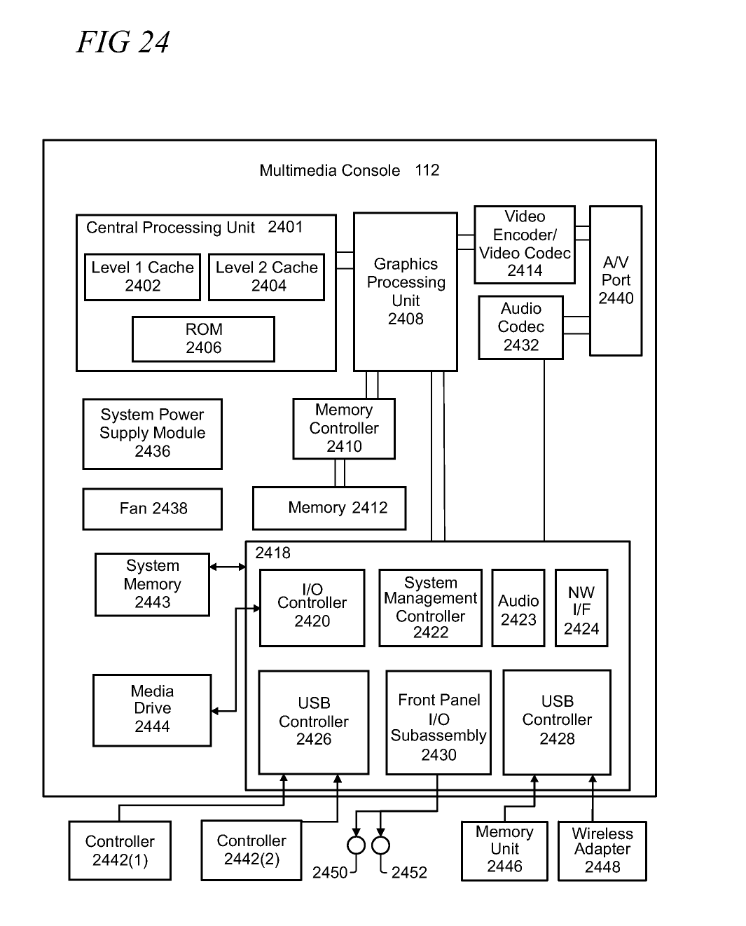

FIG. 24 is an illustrative functional block diagram of the multimedia console 112 shown in FIG. 1. The multimedia console 112 has a central processing unit (CPU) 2401 having a level 1 cache 2402, a level 2 cache 2404, and a Flash ROM (Read Only Memory) 2406. The level 1 cache 2402 and the level 2 cache 2404 temporarily store data and hence reduce the number of memory access cycles, thereby improving processing speed and throughput. The CPU 2401 may be configured with more than one core, and thus, additional level 1 and level 2 caches 2402 and 2404. The Flash ROM 2406 may store executable code that is loaded during an initial phase of a boot process when the multimedia console 112 is powered ON.

A graphics processing unit (GPU) 2408 and a video encoder/video codec (coder/decoder) 2414 form a video processing pipeline for high speed and high resolution graphics processing. Data is carried from the GPU 2408 to the video encoder/video codec 2414 via a bus. The video processing pipeline outputs data to an A/V (audio/video) port 2440 for transmission to a television or other display. A memory controller 2410 is connected to the GPU 2408 to facilitate processor access to various types of memory 2412, such as, but not limited to, a RAM.

The multimedia console 112 includes an I/O controller 2420, a system management controller 2422, an audio processing unit 2423, a network interface controller 2424, a first USB (Universal Serial Bus) host controller 2426, a second USB controller 2428, and a front panel I/O subassembly 2430 that are preferably implemented on a module 2418. The USB controllers 2426 and 2428 serve as hosts for peripheral controllers 2442(1) and 2442(2), a wireless adapter 2448, and an external memory device 2446 (e.g., Flash memory, external CD/DVD ROM drive, removable media, etc.). The network interface controller 2424 and/or wireless adapter 2448 provide access to a network (e.g., the Internet, home network, etc.) and may be any of a wide variety of various wired or wireless adapter components including an Ethernet card, a modem, a Bluetooth module, a cable modem, or the like.

System memory 2443 is provided to store application data that is loaded during the boot process. A media drive 2444 is provided and may comprise a DVD/CD drive, hard drive, or other removable media drive, etc. The media drive 2444 may be internal or external to the multimedia console 112. Application data may be accessed via the media drive 2444 for execution, playback, etc. by the multimedia console 112. The media drive 2444 is connected to the I/O controller 2420 via a bus, such as a Serial ATA bus or other high speed connection (e.g., IEEE 1394).

The system management controller 2422 provides a variety of service functions related to assuring availability of the multimedia console 112. The audio processing unit 2423 and an audio codec 2432 form a corresponding audio processing pipeline with high fidelity and stereo processing. Audio data is carried between the audio processing unit 2423 and the audio codec 2432 via a communication link. The audio processing pipeline outputs data to the A/V port 2440 for reproduction by an external audio player or device having audio capabilities.

The front panel I/O subassembly 2430 supports the functionality of the power button 2450 and the eject button 2452, as well as any LEDs (light emitting diodes) or other indicators exposed on the outer surface of the multimedia console 112. A system power supply module 2436 provides power to the components of the multimedia console 112. A fan 2438 cools the circuitry within the multimedia console 112.

The CPU 2401, GPU 2408, memory controller 2410, and various other components within the multimedia console 112 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 112 is powered ON, application data may be loaded from the system memory 2443 into memory 2412 and/or caches 2402 and 2404 and executed on the CPU 2401. The application may present a graphical user interface that provides a consistent user experience when navigating to different media types available on the multimedia console 112. In operation, applications and/or other media contained within the media drive 2444 may be launched or played from the media drive 2444 to provide additional functionalities to the multimedia console 112.

The multimedia console 112 may be operated as a standalone system by simply connecting the system to a television or other display. In this standalone mode, the multimedia console 112 allows one or more users to interact with the system, watch movies, or listen to music. However, with the integration of broadband connectivity made available through the network interface controller 2424 or the wireless adapter 2448, the multimedia console 112 may further be operated as a participant in a larger network community.

When the multimedia console 112 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbps), etc. Because these resources are reserved at system boot time, the reserved resources do not exist from the application's view.

In particular, the memory reservation preferably is large enough to contain the launch kernel, concurrent system applications, and drivers. The CPU reservation is preferably constant such that if the reserved CPU usage is not used by the system applications, an idle thread will consume any unused cycles.

With regard to the GPU reservation, lightweight messages generated by the system applications (e.g., pop-ups) are displayed by using a GPU interrupt to schedule code to render pop-ups into an overlay. The amount of memory needed for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV re-sync is eliminated.

After the multimedia console 112 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 2401 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 2442(1) and 2442(2)) are shared by gaming applications and system applications. The input devices are not reserved resources, but are to be switched between system applications and the gaming application such that each will have a focus of the device. The application manager preferably controls the switching of input stream, without knowledge of the gaming application's knowledge and a driver maintains state information regarding focus switches.

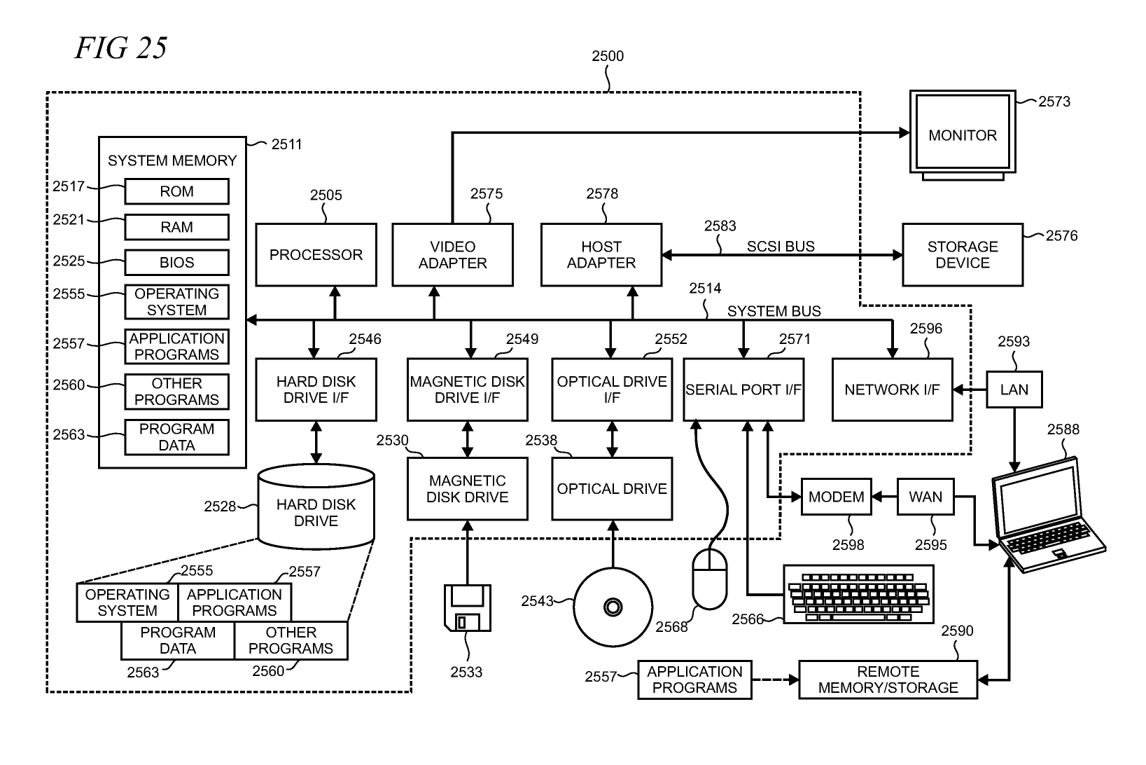

FIG. 25 is a simplified block diagram of an illustrative computer system 2500 such as a PC, client device, or server with which the present multitasking experiences with interactive PIP may be implemented. Computer system 2500 includes a processing unit 2505, a system memory 2511, and a system bus 2514 that couples various system components including the system memory 2511 to the processing unit 2505. The system bus 2514 may be any of several types of bus structures including a memory bus or memory controller, a peripheral bus, and a local bus using any of a variety of bus architectures. The system memory 2511 includes read only memory (“ROM”) 2517 and random access memory (“RAM”) 2521. A basic input/output system (“BIOS”) 2525, containing the basic routines that help to transfer information between elements within the computer system 2500, such as during startup, is stored in ROM 2517. The computer system 2500 may further include a hard disk drive 2528 for reading from and writing to an internally disposed hard disk (not shown), a magnetic disk drive 2530 for reading from or writing to a removable magnetic disk 2533 (e.g., a floppy disk), and an optical disk drive 2538 for reading from or writing to a removable optical disk 2543 such as a CD (compact disc), DVD (digital versatile disc), or other optical media. The hard disk drive 2528, magnetic disk drive 2530, and optical disk drive 2538 are connected to the system bus 2514 by a hard disk drive interface 2546, a magnetic disk drive interface 2549, and an optical drive interface 2552, respectively. The drives and their associated computer readable storage media provide non-volatile storage of computer readable instructions, data structures, program modules, and other data for the computer system 2500. Although this illustrative example shows a hard disk, a removable magnetic disk 2533, and a removable optical disk 2543, other types of computer readable storage media which can store data that is accessible by a computer such as magnetic cassettes, flash memory cards, digital video disks, data cartridges, random access memories (“RAMs”), read only memories (“ROMs”), and the like may also be used in some applications of the present multitasking experiences with interactive PIP. In addition, as used herein, the term computer readable storage medium includes one or more instances of a media type (e.g., one or more magnetic disks, one or more CDs, etc.). For purposes of this specification and the claims, the phrase “computer-readable storage media” and variations thereof, does not include waves, signals, and/or other transitory and/or intangible communication media.

A number of program modules may be stored on the hard disk, magnetic disk 2533, optical disk 2543, ROM 2517, or RAM 2521, including an operating system 2555, one or more application programs 2557, other program modules 2560, and program data 2563. A user may enter commands and information into the computer system 2500 through input devices such as a keyboard 2566 and pointing device 2568 such as a mouse. Other input devices (not shown) may include a microphone, joystick, game pad, satellite dish, scanner, trackball, touchpad, touch screen, touch-sensitive module or device, gesture-recognition module or device, voice recognition module or device, voice command module or device, or the like. These and other input devices are often connected to the processing unit 2505 through a serial port interface 2571 that is coupled to the system bus 2514, but may be connected by other interfaces, such as a parallel port, game port, or USB. A monitor 2573 or other type of display device is also connected to the system bus 2514 via an interface, such as a video adapter 2575. In addition to the monitor 2573, personal computers typically include other peripheral output devices (not shown), such as speakers and printers. The illustrative example shown in FIG. 25 also includes a host adapter 2578, a Small Computer System Interface (“SCSI”) bus 2583, and an external storage device 2576 connected to the SCSI bus 2583.

The computer system 2500 is operable in a networked environment using logical connections to one or more remote computers, such as a remote computer 2588. The remote computer 2588 may be selected as another personal computer, a server, a router, a network PC, a peer device, or other common network node, and typically includes many or all of the elements described above relative to the computer system 2500, although only a single representative remote memory/storage device 2590 is shown in FIG. 25. The logical connections depicted in FIG. 25 include a local area network (“LAN”) 2593 and a wide area network (“WAN”) 2595. Such networking environments are often deployed, for example, in offices, enterprise-wide computer networks, intranets, and the Internet.

When used in a LAN networking environment, the computer system 2500 is connected to the local area network 2593 through a network interface or adapter 2596. When used in a WAN networking environment, the computer system 2500 typically includes a broadband modem 2598, network gateway, or other means for establishing communications over the wide area network 2595, such as the Internet. The broadband modem 2598, which may be internal or external, is connected to the system bus 2514 via a serial port interface 2571. In a networked environment, program modules related to the computer system 2500, or portions thereof, may be stored in the remote memory storage device 2590. It is noted that the network connections shown in FIG. 25 are illustrative and other means of establishing a communications link between the computers may be used depending on the specific requirements of an application of multitasking experiences with interactive PIP. It may be desirable and/or advantageous to enable other types of computing platforms other than the multimedia console 112 to implement the present multitasking experiences with interactive PIP in some applications.

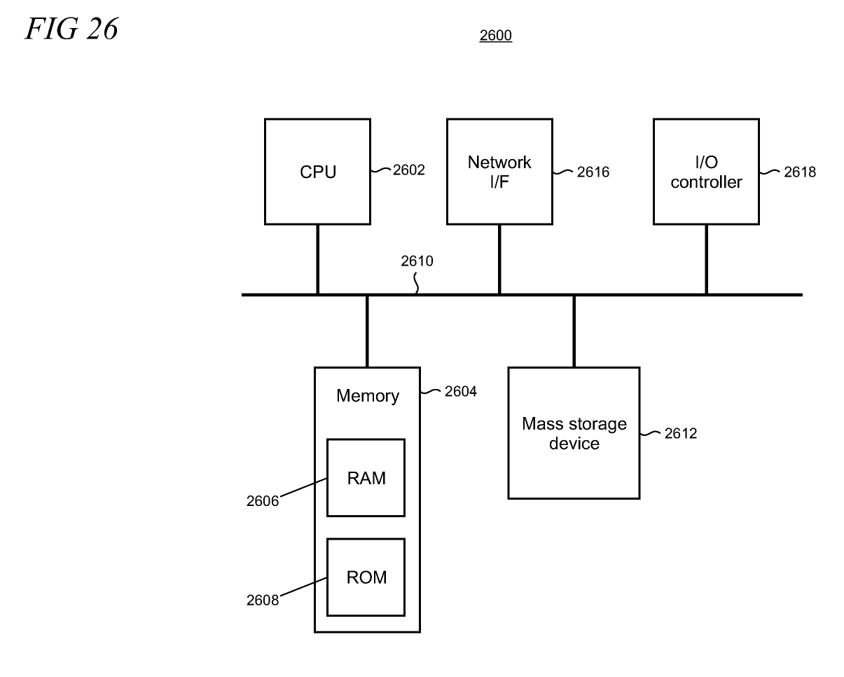

FIG. 26 shows an illustrative architecture 2600 for a computing platform or device capable of executing the various components described herein for multitasking experiences with interactive PIP. Thus, the architecture 2600 illustrated in FIG. 26 shows an architecture that may be adapted for a server computer, mobile phone, a PDA (personal digital assistant), a smartphone, a desktop computer, a netbook computer, a tablet computer, GPS (Global Positioning System) device, gaming console, and/or a laptop computer. The architecture 2600 may be utilized to execute any aspect of the components presented herein.

The architecture 2600 illustrated in FIG. 26 includes a CPU 2602, a system memory 2604, including a RAM 2606 and a ROM 2608, and a system bus 2610 that couples the memory 2604 to the CPU 2602. A basic input/output system containing the basic routines that help to transfer information between elements within the architecture 2600, such as during startup, is stored in the ROM 2608. The architecture 2600 further includes a mass storage device 2612 for storing software code or other computer-executed code that is utilized to implement applications, the file system, and the operating system.

The mass storage device 2612 is connected to the CPU 2602 through a mass storage controller (not shown) connected to the bus 2610. The mass storage device 2612 and its associated computer-readable storage media provide non-volatile storage for the architecture 2600. Although the description of computer-readable storage media contained herein refers to a mass storage device, such as a hard disk or CD-ROM drive, it should be appreciated by those skilled in the art that computer-readable media can be any available computer storage media that can be accessed by the architecture 2600.

By way of example, and not limitation, computer-readable storage media may include volatile and non-volatile, removable and non-removable media implemented in any method or technology for storage of information such as computer-readable instructions, data structures, program modules or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), BLU-RAY, or other optical storage, magnetic cassettes, magnetic tape, magnetic disk storage or other magnetic storage devices, or any other medium which can be used to store the desired information and which can be accessed by the architecture 2600.

According to various embodiments, the architecture 2600 may operate in a networked environment using logical connections to remote computers through a network. The architecture 2600 may connect to the network through a network interface unit 2616 connected to the bus 2610. It should be appreciated that the network interface unit 2616 also may be utilized to connect to other types of networks and remote computer systems. The architecture 2600 also may include an input/output controller 2618 for receiving and processing input from a number of other devices, including a keyboard, mouse, or electronic stylus (not shown in FIG. 26). Similarly, the input/output controller 2618 may provide output to a display screen, a printer, or other type of output device (also not shown in FIG. 26).

It should be appreciated that the software components described herein may, when loaded into the CPU 2602 and executed, transform the CPU 2602 and the overall architecture 2600 from a general-purpose computing system into a special-purpose computing system customized to facilitate the functionality presented herein. The CPU 2602 may be constructed from any number of transistors or other discrete circuit elements, which may individually or collectively assume any number of states. More specifically, the CPU 2602 may operate as a finite-state machine, in response to executable instructions contained within the software modules disclosed herein. These computer-executable instructions may transform the CPU 2602 by specifying how the CPU 2602 transitions between states, thereby transforming the transistors or other discrete hardware elements constituting the CPU 2602.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the architecture 2600 in order to store and execute the software components presented herein. It also should be appreciated that the architecture 2600 may include other types of computing devices, including hand-held computers, embedded computer systems, smartphones, PDAs, and other types of computing devices known to those skilled in the art. It is also contemplated that the architecture 2600 may not include all of the components shown in FIG. 26, may include other components that are not explicitly shown in FIG. 26, or may utilize an architecture completely different from that shown in FIG. 26.

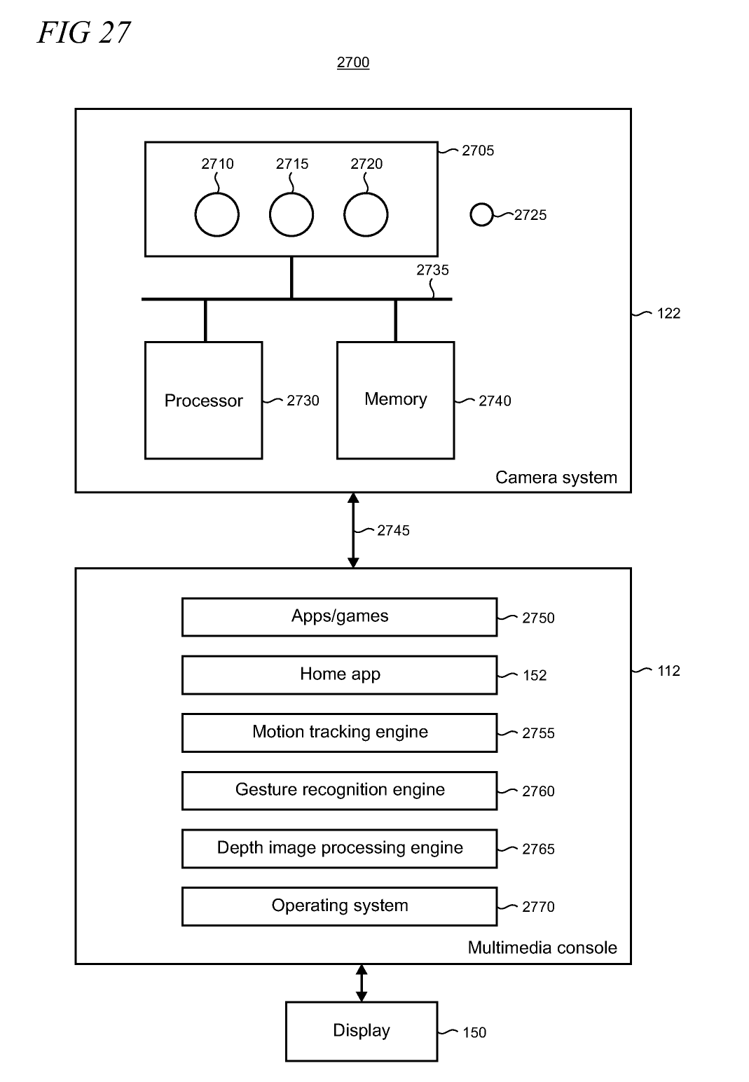

FIG. 27 shows illustrative functional components of the camera system 122 that may be used as part of a target recognition, analysis, and tracking system 2700 to recognize human and non-human targets in a capture area of a physical space monitored by the camera system without the use of special sensing devices attached to the subjects, uniquely identify them, and track them in three-dimensional space. The camera system 122 may be configured to capture video with depth information including a depth image that may include depth values via any suitable technique including, for example, time-of-flight, structured light, stereo image, or the like. In some implementations, the camera system 122 may organize the calculated depth information into “Z layers,” or layers that may be perpendicular to a Z-axis extending from the depth camera along its line of sight.

As shown in FIG. 27, the camera system 122 includes an image camera component 2705. The image camera component 2705 may be configured to operate as a depth camera that may capture a depth image of a scene. The depth image may include a two-dimensional (2D) pixel area of the captured scene where each pixel in the 2D pixel area may represent a depth value such as a distance in, for example, centimeters, millimeters, or the like of an object in the captured scene from the camera. In this example, the image camera component 2705 includes an IR light component 2710, an IR camera 2715, and a visible light RGB camera 2720 that may be configured in an array, as shown, or in an alternative geometry.

Various techniques may be utilized to capture depth video frames. For example, in time-of-flight analysis, the IR light component 2710 of the camera system 122 may emit an infrared light onto the capture area and may then detect the backscattered light from the surface of one or more targets and objects in the capture area using, for example, the IR camera 2715 and/or the RGB camera 2720. In some embodiments, pulsed infrared light may be used such that the time between an outgoing light pulse and a corresponding incoming light pulse may be measured and used to determine a physical distance from the camera system 122 to a particular location on the targets or objects in the capture area. Additionally, the phase of the outgoing light wave may be compared to the phase of the incoming light wave to determine a phase shift. The phase shift may then be used to determine a physical distance from the capture device to a particular location on the targets or objects. Time-of-flight analysis may be used to indirectly determine a physical distance from the camera system 122 to a particular location on the targets or objects by analyzing the intensity of the reflected beam of light over time via various techniques including, for example, shuttered light pulse imaging.

In other implementations, the camera system 122 may use structured light to capture depth information. In such an analysis, patterned light (i.e., light displayed as a known pattern such as a grid pattern or a stripe pattern) may be projected onto the capture area via, for example, the IR light component 2710. Upon striking the surface of one or more targets or objects in the capture area, the pattern may become deformed in response. Such a deformation of the pattern may be captured by, for example, the IR camera 2715 and/or the RGB camera 2720 and may then be analyzed to determine a physical distance from the capture device to a particular location on the targets or objects.

The camera system 122 may utilize two or more physically separated cameras that may view a capture area from different angles, to obtain visual stereo data that may be resolved to generate depth information. Other types of depth image arrangements using single or multiple cameras can also be used to create a depth image. The camera system 122 may further include a microphone 2725. The microphone 2725 may include a transducer or sensor that may receive and convert sound into an electrical signal. The microphone 2725 may be used to reduce feedback between the camera system 122 and the multimedia console 112 in the target recognition, analysis, and tracking system 2700. Additionally, the microphone 2725 may be used to receive audio signals that may also be provided by the user 110 to control applications such as game applications, non-game applications, or the like that may be executed by the multimedia console 112.

The camera system 122 may further include a processor 2730 that may be in operative communication with the image camera component 2705 over a bus 2740. The processor 2730 may include a standardized processor, a specialized processor, a microprocessor, or the like that may execute instructions that may include instructions for storing profiles, receiving the depth image, determining whether a suitable target may be included in the depth image, converting the suitable target into a skeletal representation or model of the target, or any other suitable instruction. The camera system 122 may further include a memory component 2740 that may store the instructions that may be executed by the processor 2730, images or frames of images captured by the cameras, user profiles or any other suitable information, images, or the like. According to one example, the memory component 2740 may include RAM, ROM, cache, Flash memory, a hard disk, or any other suitable storage component. As shown in FIG. 27, the memory component 2740 may be a separate component in communication with the image capture component 2705 and the processor 2730. Alternatively, the memory component 2740 may be integrated into the processor 2730 and/or the image capture component 2705. In one embodiment, some or all of the components 2705, 2710, 2715, 2720, 2725, 2730, 2735, and 2740 of the capture device 122 are located in a single housing.

The camera system 122 operatively communicates with the multimedia console 112 over a communication link 2745. The communication link 2745 may be a wired connection including, for example, a USB (Universal Serial Bus) connection, a Firewire connection, an Ethernet cable connection, or the like and/or a wireless connection such as a wireless IEEE 802.11 connection. The multimedia console 112 can provide a clock to the camera system 122 that may be used to determine when to capture, for example, a scene via the communication link 2745. The camera system 122 may provide the depth information and images captured by, for example, the IR camera 2715 and/or the RGB camera 2720, including a skeletal model and/or facial tracking model that may be generated by the camera system 122, to the multimedia console 112 via the communication link 2745. The multimedia console 112 may then use the skeletal and/or facial tracking models, depth information, and captured images to, for example, create a virtual screen, adapt the user interface, and control apps/games 2750.

A motion tracking engine 2755 uses the skeletal and/or facial tracking models and the depth information to provide a control output to one more apps/games 2750 running on the multimedia console 112 to which the camera system 122 is coupled. The information may also be used by a gesture recognition engine 2760, depth image processing engine 2765, and/or operating system 2770.

The depth image processing engine 2765 uses the depth images to track motion of objects, such as the user and other objects. The depth image processing engine 2765 will typically report to the operating system 2770 an identification of each object detected and the location of the object for each frame. The operating system 2770 can use that information to update the position or movement of an avatar, for example, or other images shown on the display 150, or to perform an action on the user interface.

The gesture recognition engine 2760 may utilize a gestures library (not shown) that can include a collection of gesture filters, each comprising information concerning a gesture that may be performed, for example, by a skeletal model (as the user moves). The gesture recognition engine 2760 may compare the frames captured by the camera system 112 in the form of the skeletal model and movements associated with it to the gesture filters in the gesture library to identify when a user (as represented by the skeletal model) has performed one or more gestures. Those gestures may be associated with various controls of an application and direct the system to open the personalized home screen as described above. Thus, the multimedia console 112 may employ the gestures library to interpret movements of the skeletal model and to control an operating system or an application running on the multimedia console based on the movements.

In some implementations, various aspects of the functionalities provided by the apps/games 2750, motion tracking engine 2755, gesture recognition engine 2760, depth image processing engine 2765, and/or operating system 2770 may be directly implemented on the camera system 122 itself.

Based on the foregoing, it should be appreciated that technologies for multitasking experiences with interactive PIP have been disclosed herein. Although the subject matter presented herein has been described in language specific to computer structural features, methodological and transformative acts, specific computing machinery, and computer-readable storage media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed:

1. In a multimedia console, a method comprising:
receiving a user input event from an input device for navigating to a home screen displayed on a user interface (“UI”) supported on the multimedia console, the received user input event comprising one of a control manipulation on a multimedia console controller, a gesture recognized by a gesture recognition system, or a voice command;
opening the home screen in response to the received user input, the home screen including a plurality of graphic tiles each representing respective applications that are executable on the multimedia console when a corresponding graphic tile is selected, one the plurality of graphic tiles being adapted as a picture-in-picture (“PIP”) within the UI;
receiving a system state describing applications that are currently running on the multimedia console;
dynamically rendering the home screen including the plurality of graphic tiles and the PIP using the received state information; and
switching focus between graphic tiles responsively to user input events from the input device, in which user input events received at the UI are directed to an application associated with the graphic tile having focus.

2. The method of claim 1 further including a step of configuring the PIP to be relatively larger than the other graphic tiles included on the home screen.

3. The method of claim 1 further including a step of enabling a user to select applications for inclusion as pins on the home screen, the pins comprising graphic tiles associated with the user-selected applications and the pins being displayed as some or all of the plurality of graphic tiles included on the home screen.

4. The method of claim 1 further including a step of redirecting video output produced by an application so that the video output can be manipulated for use on the home screen, the manipulation including one of scaling, repositioning, or resizing.

5. The method of claim 1 in which the control manipulation comprises a single button press.

6. The method of claim 1 in which “home” or its non-English language equivalents is included as a word in the voice command.

7. The method of claim 1 further including a step of enabling the UI to go into full screen to render video output of an application associated with a selected graphic tile.

8. The method of claim 1 further including a step of providing a snapped application menu that lists one or more snappable applications, a snappable application having a UI that is rendered into a portion of the PIP tile when snapped.

9. One or more computer-readable storage media containing instructions which, when executed by one or more processors disposed in an electronic device having an associated controller, perform a method for providing a user interface (“UI”), comprising:
rendering a home screen on the UI, the home screen including a picture-in-picture (“PIP”) tile, one or more most recently used application tiles, and one or more pinned application tiles, each of the tiles being graphic elements on the home screen that are associated with applications that are executable on the device, the PIP tile displaying graphic output of one or more currently executing applications;
rendering the graphic output of the one or more currently executing applications in a full screen on the UI in response to user selection of the PIP tile;
returning to the home screen on the UI from the full screen in response to a single button push on the controller, a gesture recognized by a gesture recognition system, or a voice command; and
rendering the graphic output of a snapped application into the PIP tile concurrently with the graphic output of the one or more currently executing applications.

10. The one or more computer-readable storage media of claim 9 further including rendering the graphic output of a snapped application into the full screen concurrently with the graphic output of the currently executing application.

11. The one or more computer-readable storage media of claim 9 further including displaying an in-experience menu that is contextually applicable to the currently executing application or the snapped application.

12. The one or more computer-readable storage media of claim 9 further including capturing video output produced by the currently executing application and modifying the captured video output for display in the PIP tile.

13. The one or more computer-readable storage media of claim 9 further including capturing video output rendered by applications and modifying the captured video output for display on the home screen.

14. The one or more computer-readable storage media of claim 13 in which the capturing comprises exposing Direct Composition surfaces corresponding to the rendering applications.

15. The one or more computer-readable storage media of claim 9 further including switching focus between the snapped application and currently executing application.

16. A system comprising:
a processor; and
one or more computer-readable storage media storing instructions which, when executed by the processor, implement a user interface (“UI”) including
a full screen in which video output from an application executing on the system is rendered;
a home screen that is invocable from the full screen responsively to user input to the system,
a plurality of tiles displayed on the home screen, each tile representing an application that is executable on the system when invoked by user input to the system,
a picture-in-picture (“PIP”) the displayed on the home screen into which modified video output from the executing application is rendered when the home screen is displayed, and
a user-selectable snappable application that, when snapped, has video output rendered into a window in the full screen when the full screen is displayed and has video output rendered into a window in the PIP tile when the home screen is displayed.

17. The system of claim 16 further including an in-experience menu that is contextually related to an application associated with a selected tile.

18. The system of claim 16 in which the modified video output is resized, scaled, or repositioned when compared to the non-modified video output.

19. The system of claim 16 in which the system is implemented on a multimedia console and the user input is captured at a controller coupled to the multimedia console.

20. The system of claim 16 further including at least one of tiles for most recently used applications, tiles representing applications running as background applications, or tiles for pinned applications.
